(19) United States
(12) Patent Application Publication
(10) Pub. No.: US 2007/0193655 A1
(43) Pub. Date: Aug. 23, 2007

(54) Extraction of non-contiguous component panels from a panel

(75) Inventor: Michael Lee, Danville, VA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Columbia Forest Products, Inc.

(21) Appl. No.: 11/350,052

(22) Filed: Feb. 7, 2006

(51) Int. Cl. B27D 1/00

(52) U.S. Cl. 144/348

(57) ABSTRACT

Embodiments of apparatuses, articles, methods, and systems for extracting components from a panel are generally described herein. Other embodiments may be described and claimed.

### FIELD

Embodiments of the present invention relate generally to the field of panel manufacture, and more particularly to the manufacture of component panels.

### BACKGROUND

A plywood panel typically consists of one or more layers, or plies, coupled together to form a panel. Often the plies include a core sandwiched between two, approximately like-dimensioned, veneer sheets. The outer veneer sheets may be referred to as a back and a face. A face may be a whole piece or a number of smaller pieces jointed together to form a full-sized sheet. The small pieces may be jointed together by edge gluing, stitching, or using perforated paper adhesive tape.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a panel in accordance with an embodiment of the present invention;

FIG. 2 illustrates a cross-sectional view of the panel in accordance with an embodiment of the present invention;

FIG. 3 illustrates a manufacturing system for forming and/or extracting component panels from the panel in accordance with an embodiment of the present invention;

FIG. 4 illustrates a process for producing the components in accordance with an embodiment of the present invention;

FIG. 5 illustrates a process for assembling the panel in accordance with an embodiment of the present invention;

FIG. 6 illustrates a process for extracting component panels from the panel in accordance with an embodiment of the present invention;

FIG. 7 illustrates a panel-assembly facility in accordance with an embodiment of the present invention;

FIG. 8 illustrates an assembly system in accordance with an embodiment of the present invention;

FIG. 9 illustrates a component panel-extraction facility in accordance with an embodiment of the present invention;

FIG. 10 illustrates the component panel-extraction facility in more detail in accordance with an embodiment of the present invention;

FIG. 11 illustrates a component panel-extraction facility in accordance with an embodiment of the present invention; and

FIG. 12 illustrates an extraction system in accordance with an embodiment of the present invention.

### DETAILED DESCRIPTION

Illustrative embodiments of the present invention may include apparatuses and methods involving a panel having non-contiguous components coupled to a substrate and/or systems, apparatuses, and/or methods for the manufacturing and/or processing of the same.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B)” ; that is, A is optional.

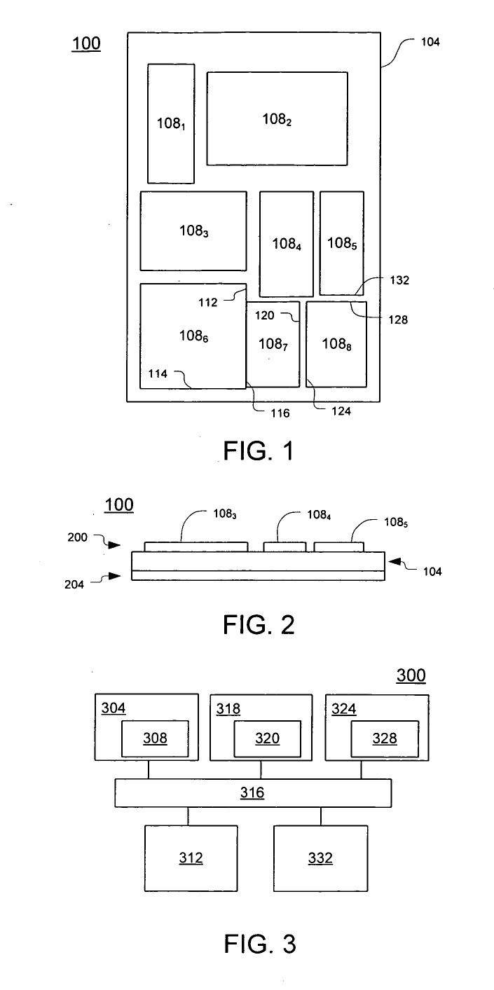

FIG. 1 illustrates a panel 100 in accordance with an embodiment of the present invention. The panel 100 may be a plywood panel that is constructed of a number of layers, or plies, of wood or wood-like substances. The panel 100 may include layers having compositions and/or arrangements to provide for an attractive surface appearance, a desirable strength-to-weight ratio, and/or an economical cost structure. In various embodiments, the panel 100 may be intended for use in interior or exterior environments.

The panel 100 may include a substrate 104 having coupled thereto a plurality of components 108. As shown in this embodiment, there may be eight components 108₁₋₈; however, other embodiments may have other number of components.

The components 108 may be arranged in a non-contiguous manner. As used herein, a non-contiguous arrangement of the components 108 may be an arrangement to facilitate the detection and/or identification of characteristics of the individual components 108 such as, but not limited to, dimensions and/or layout of the components 108.

In one embodiment, a non-contiguous manner may be such that complementary edges on adjacent components are non-abutting and/or non-coextensive with each other. For example, non-contiguous components may have edges that abut one another but are not coextensive, e.g., edge 112 of component 108₆ and edge 116 of component 108₇; edges that are coextensive but do not abut one another, e.g., edge 120 of component 108₇ and edge 124 of component 108₈; and/or edges that are neither coextensive nor abutting one another, e.g., edge 128 of component 108₈ and edge 132 of component 108₅.

A non-contiguous arrangement of components 108 may use less of the underlying substrate than having a uniform, contiguous face and may complicate the extraction of the components in subsequent operations of prior art manufacturing facilities. Nevertheless, teachings of the embodiments of the present invention recognizing the advantages in the utilization of smaller, discrete face components, when coupled with other embodiments of the present invention that may facilitate efficient extraction of said components, may allow for the realization of said advantages in a commercially feasible context.

FIG. 2 illustrates a cross-sectional view of the panel 100, in accordance with an embodiment of the present invention. In this embodiment, the substrate 104, which may also be referred to as a core layer 104, may be coupled to veneer layer 200 and veneer layer 204. In some embodiments the veneer layer 200, which includes the components 108, may also be referred to as a face layer 200, while the veneer layer 204 may also be referred to as the back layer 204. The face and back descriptors may be used to facilitate discussion of the illustrated embodiments and do not necessarily restrict embodiments of the present invention. For example, while the face layer 200 is shown to include the plurality of components 108, in other embodiments the back layer 204 may additionally/alternatively include one or more components. Furthermore, in accordance with some embodiments, the panel 100 may include only one of the veneer layers, e.g., the face layer 200 or the back layer 204, and the substrate 104.

In various embodiments, the layers, or portions thereof, may be composed of a wide variety of wood species including both hardwoods and softwoods. In various embodiments all of the layers may be of the same or of different compositions.

In various embodiments, the core layer 104 may include a number of veneer plies with their grains in alternating and/or parallel directions; a number of sawn timber battens sandwiched between two or more veneer plies; or a number of veneer plies at right angles to two or more veneer plies in which they are sandwiched between. Panels having these types of core layers may be referred to as veneer plywood panels, blackboard panels, and laminboard panels, respectively. In various embodiments, the core layer 104 may include any number of plies in a wide variety of arrangements. The core layer 104 may additionally/alternatively include a core material of, for example, lumber, particleboard, medium-density fiber (MDF), and/or hardboard.

The layers of the panel 100 may be bonded to one another with an adhesive adapted for the particular environment in which the panel 100 is intended to be used. These adhesives could include, but are not limited to, urea-formaldehyde (UF), phenol-formaldehyde (PF), melamine-urea-formaldehyde (MUF), and/or formaldehyde-free adhesives (e.g., soy-based adhesives).

FIG. 3 illustrates a manufacturing system 300 for forming the panel 100 and subsequently extracting the component panels, in accordance with an embodiment of the present invention. In this embodiment, a back layer source 304, having a backing production facility 308 to produce the back layer 204, may source the back layer 204 to a panel-assembly facility 312 via a transport unit 316. Sourcing, as used herein, may include both direct provisioning, e.g., providing the back layer 204 to the panel-assembly facility 312 immediately following the production of the back layer 204, as well as indirect provisioning, e.g., providing the back layer 204 to the panel-assembly facility 312 after one or more intervening operations such as, but not limited to, a storage operation and/or another manufacturing operation. A core-layer source 318, having a core production facility 320 to produce the core layer 104, may source the core layer 104 to the panel-assembly facility 312 via the transport unit 316. A component source 324, having a component-production facility 328 to produce the components 108, may source the components 108 to the panel-assembly facility 312 via the transport unit.

In various embodiments, the transport unit 316 may include one or more transport elements to perform the various transport operations. The transport unit 316 may include automated and/or manual transport elements for remote and/or local transport operations.

While the various source and facility combinations of system 300 are shown as separate entities in FIG. 3, there may be some overlap in some embodiments. For example, in one embodiment the back layer source 304 may source a veneer layer to the component source 324 and/or the core-layer source 318.

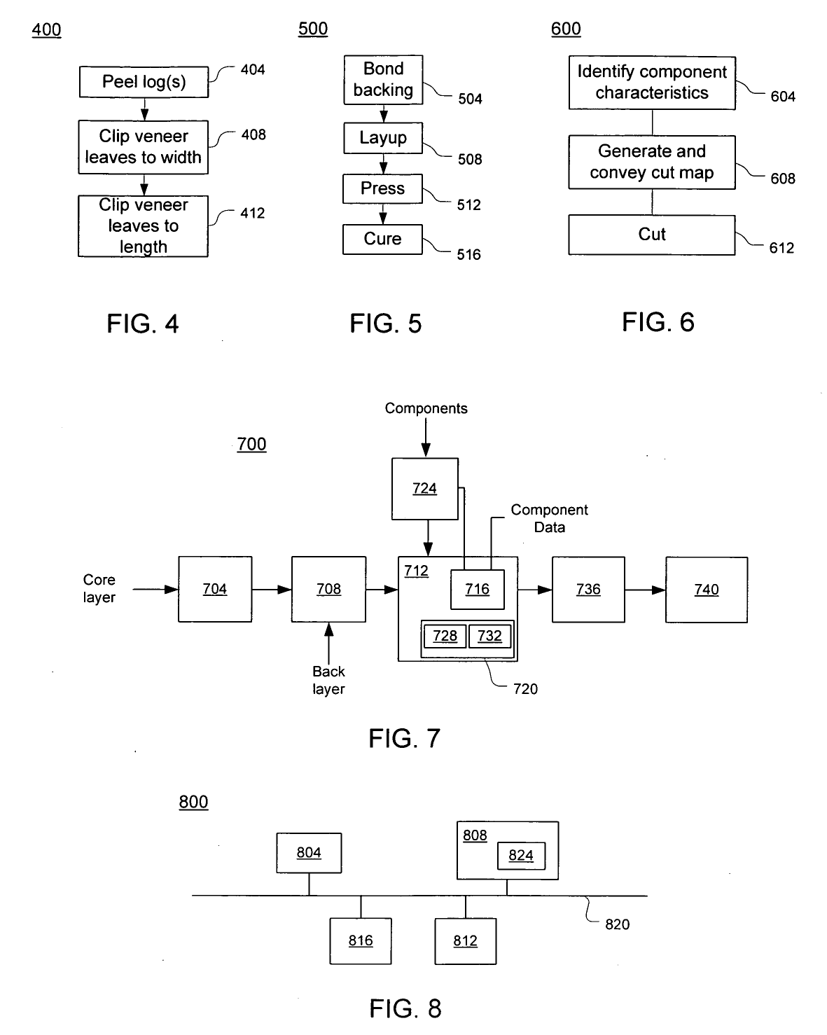

FIG. 4 illustrates a process 400 for producing the components 108 in accordance with an embodiment of the present invention. In this embodiment, the component source 324, and more particularly the component-production facility 328, may prepare the components 108 as follows.

In an embodiment where the components 108 are composed of a wood species, the early preparation of the components 108 may include the peeling of one or more logs (404). Reference numbers referring to operations of processes described herein may be designated within parentheses. The peeling of the log(s) (404) may result in long strips of wood, sometimes referred to as veneer leaves, having relatively uniform thicknesses.

The veneer leaves may then be clipped to width (408) and to length (412), thereby providing the components 108 with various dimensions. In some embodiments, the dimensions of the components 108 may be demand-driven, e.g., based on customer orders. In some embodiments, the dimensions of the components 108 may be supply-driven, e.g., based on features of the veneer leaves themselves, e.g., nonconformities of the wood or size and/or shape of the veneer pieces. In some embodiments, the flexibility provided by using supply-driven component dimensions may increase the yield of a given log. For example, components 108 may be cut around nonconformities that exist in a given veneer leaf. Utilization of the components 108, whatever dimensions they may be, may be facilitated by embodiments described herein.

Referring again to FIG. 3, the panel-assembly facility 312 may receive the core layer 104, the back layer 204, and the components 108 from the transport unit 316. The panel-assembly facility 312 may then assemble the panel 100 as shown in the process 500 depicted in FIG. 5 in accordance with an embodiment of the present invention.

The panel-assembly facility 312 may bond the back layer 204 to the core layer 104 by disposing an adhesive between the two layers (504). The panel-assembly facility 312 may also perform a layup operation (508) by coating the surface of the core layer 104 opposite the back layer 204 and/or components 108 with an adhesive and arranging the components 108 on the surface in a non-contiguous manner, as described above. The panel-assembly facility 312 may then press the components 108, the core layer 104, and the back layer 204 (512) and cure (516) thereby providing the panel 100. In various embodiments a hot press or a cold press operation may be used. The panel-assembly facility 312 may sand the panel 100 if desired.

Referring once again to FIG. 3, the panel-assembly facility 312 may source the panel 100 to a component-panel extraction (CPE) facility 332 in accordance with an embodiment of the present invention. FIG. 6 illustrates a process 600 for the CPE facility 332 extracting component panels from the panel 100 in accordance with an embodiment of the present invention.

The CPE facility 332 may initially identify characteristics of the components 108 such as, for example, dimensions and layouts of the components 108 (604). In one embodiment, the layout of the components 108 may be relative to the perimeter of the core layer 104. In other embodiments, some of which will be described in further detail below, other reference markers may be used.

The CPE facility 332 may then generate a cut map detailing the cutting pattern to be used for extracting the component-panels from the panel 100 (608). The CPE facility 332 may then extract the component panels by cutting the panel 100 according to the cut map (612).

FIG. 7 illustrates a panel-assembly facility 700 in accordance with an embodiment of the present invention. The panel-assembly facility 700 may be substantially interchangeable with the panel-assembly facility 312 shown and described in FIG. 3. The panel-assembly facility 700 may include a spreader 704 to receive the core layer 104 and apply a thin layer of adhesive to the surfaces. A backer 708 may receive the core layer 104 and couple the back layer 204 to a first surface of the core layer 104. The backer 708 may transfer the back layer 204 and core layer 104 to a component layup unit 712.

In one embodiment, the component layup unit 712 may have a nesting pattern generator 716 to receive data on the components 108 such as, but not limited to, dimensions of the components 108. The nesting pattern generator 716 may receive the component data and generate a pattern for placement of the components 108 on the second surface of the core layer 104, which may be opposite the first surface. The nesting pattern generator 716 may also have data on the dimensions of the core layer 104; however, these dimensions may be less variable than the dimensions of the components 108.

In various embodiments, the nesting pattern generator 716 may receive the component data from the component source 324, from a user interface 720, or from an automated measurement process. Likewise, the nesting pattern generator 716 may receive the core layer data from the core-layer source 318, from a user interface, or from an automated measurement process.

The nesting pattern generator 716 may generate the nesting pattern according to a variety of nesting algorithms, which may each assign various objectives varying priorities. For example, a nesting algorithm may have a high priority for utilization of the second surface of the core layer 104. This nesting algorithm may then select and position a subset of components 108 out of all of the available components 108 according to this objective. In another embodiment, a nesting algorithm may have a high priority on placing particular components 108 on a particular sheet, e.g., to group the components 108 according to a particular customer's order obtained, e.g., from a needs-list database. Therefore, in this embodiment, the nesting algorithm may be restricted in its selection of available components 108 for placement on the core layer 104. In this particular embodiment, the nesting pattern generator 716 may select components 108₁₋₈ and generate a pattern that is generally manifested in FIG. 1.

Based on the generated nesting pattern, the nesting pattern generator 716 may transmit information as to which components 108 were selected to a component puller 724. The component puller 724 may retrieve the selected components 108 and provide them to the component layup unit 712.

The user interface 720 may have a variety of input and/or output elements. In this embodiment, the user interface 720 may have a projector display element 728 and an electronic display element 732. In an embodiment, the projector display element 728 may project an image of the nesting pattern onto the core layer 104 as a visual guide for the lay up of the components 108 received from the component puller 724. In one embodiment, the projector display element 728 may project a laser image outlining the nesting pattern. The electronic display element 732 may similarly output a representation of the nesting pattern for a user. The user may reference and/or manipulate the nesting pattern output through the user interface 720.

The components 108 may be laid upon the surface of the core layer 104 as directed by the nesting pattern. In various embodiments, this material handling operation may be manual and/or automated.

After the panel 100 has been laid up with the components 108 and the back layer 204, the panel may be transferred to a press 736. The press 736 may apply sufficient pressure and/or heat to securely bond the elements of the panel 100. In various embodiments, the press 736 may be, but is not limited to, a shuttle press or a continuous press.

In some embodiments, an identifier 740 may be employed to mark the panel 100 to provide a unique identification that may be used for downstream processing and/or shipment, for example. In various embodiments, the identifier 740 may mark the panel 100 with any of a variety of identification elements such as, but not limited to, a bar code, a parts code, or a radio-frequency identification. In an embodiment, the layup pattern of the components 108 themselves may provide a unique identification of the panel 100.

As shown, the identifier 740 may receive the panel 100 from the press 736. In other embodiments, the identifier 740 may mark the panel 100 at other stages.

FIG. 8 illustrates an example assembly system 800 incorporated with at least some of the teachings of the above-described embodiment of a panel-assembly facility. In this embodiment, the assembly system 800 may have a processor/controller 804, a memory 808, an input/output interface 812, and a network interface 816 coupled to each other via bus 820.

In various embodiments, the processor/controller 804 may include one or more microprocessor, digital signal processors (DSPs), application specific integrated circuits (ASICs), and combinations of various hardware and logic circuitry for performing at least the functions described herein. In various embodiments the processor/controller 804, or elements thereof, may be a resource dedicated to the assembly system 800 or a shared resource.

The memory 808 may be employed to store instructions and/or data, more specifically, nesting control logic 824. The nesting control logic 824 may be employed to perform one or more functions such as, but not limited to, nesting pattern generation and nesting pattern output as described above.

Communication between the assembly system 800 and various peripherals, such as, but not limited to various displays of a user interface may be conducted through the input/output interface 812.

Communication between the assembly system 800 and remote elements, such as, but not limited to a needs-list database, may be conducted through the network interface 816.

In alternate systems, application specific integrated circuits (ASIC) may be employed with or as an alternative to the processor/controller 804, the memory 808, and the component-extraction control logic 824.

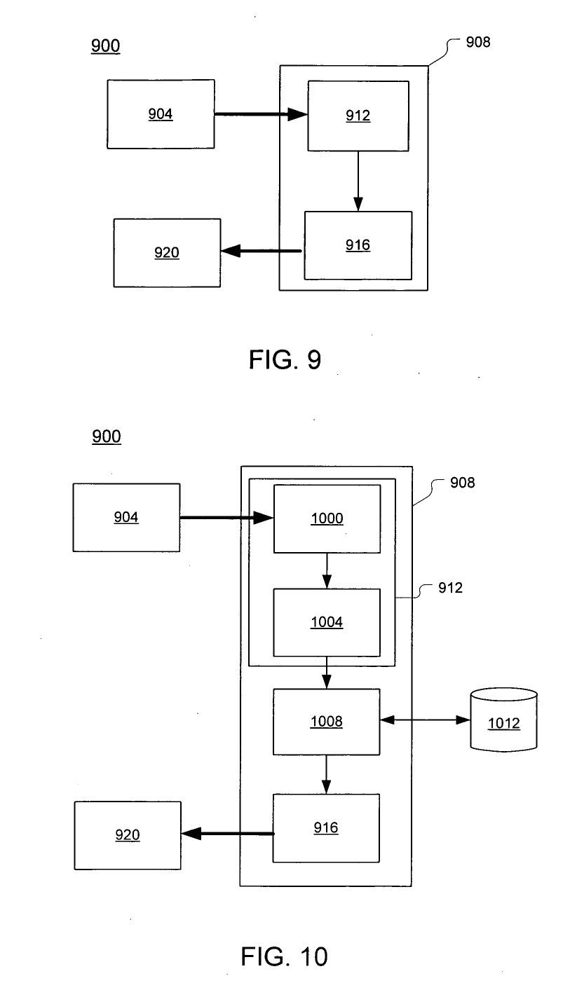

FIG. 9 illustrates a CPE facility 900 in accordance with an embodiment of the present invention. The CPE facility 900 may be substantially interchangeable with the CPE facility 332 shown and described in FIG. 3. The CPE facility 900 may include an image acquisition device 904 coupled to a mapper 908. The image acquisition device 904 may capture an image of the panel 100 and generate an image signal, representing the captured image, to be transmitted to the mapper 908.

In some embodiments, the image acquisition device 904 may illuminate the panel 100 with a light source and capture the image with a camera. The image acquisition device 904 may also include a projector element to project an image onto the surface of the panel 100. The projected image, e.g., a cross-hatched pattern, may be part of the subsequently captured image and may be used as reference guidelines by downstream processing elements. In some embodiments, the image acquisition device 904 may have more than one camera in order to provide for stereoscopic imaging, triangulation of reference points, increased resolution, and/or to permit the capture of large subjects while avoiding the distortion related to wide angle lens systems.

The mapper 908 may have an image processor 912 to receive and analyze the image signal in order to determine characteristics of the components 108 of the panel 100. The image processor 912 may communicate information about the characteristics of the components 108 to a cut map generator 916. The cut map generator 916 may then generate a cut map based at least in part on the information about the characteristics of the components 108. The mapper 908 may then transmit the cut map to a cutting device 920 for implementation.

In some embodiments, the cutting device 920 may be a programmable cutting device and the cut map may be the programming instructions transmitted for execution. For example, in some embodiments the mapper 908 may implement a computer-aided manufacturing (CAM) program to generate the cut map, with or without user input, as a series of programming instructions for implementation. These programming instructions may conform to one or more standards implemented by the American National Standards Institute (ANSI) and/or Electronics Industries Alliance (EIA) such as, for example, RS-274D approved in February of 1980 (commonly referred to as G-code). In these embodiments, the programming instructions may be transmitted to the cutting device 920, which, in this instance, may be a device capable of processing said instructions, such as, but not limited to a computer-numerical control (CNC) router.

Although certain facilities are shown as having several separate functional elements, one or more of the functional elements may be combined and may be implemented by combinations of software configured elements, such as processing elements including digital signal processors (DSPs), and/or other hardware elements. For example, the mapper 908, may comprise one or more microprocessor, DSPs, application specific integrated circuits (ASICs), and combinations of various hardware and logic circuitry for performing at least the functions of the image processor 912 and the cut map generator 916 described herein.

FIG. 10 illustrates the CPE facility 900 in accordance with an embodiment of the present invention. In this embodiment, the image processor 912 may include a framegrabber 1000 to interface with the image acquisition device 904 by receiving the image signal and converting the image signal into a format, e.g., a digital format, to facilitate downstream analysis.

The converted image signal may then be processed by a pattern identifier 1004 to detect and/or measure characteristics of the components 108. The pattern identifier 1004 may employ a variety of image processing techniques, some of which will be presently discussed. In some embodiments, the pattern identifier 1004 may employ edge detection techniques to detect the edges of the components 108 of the panel 100. The non-contiguous manner in which the components 108 are coupled to the core layer 104 may facilitate the detection of the edges. With the edges detected, the pattern identifier 1004 may calculate the dimensions and/or layout of the components 108. Other information, not reliably ascertained by image analysis may be input to the pattern identifier through other mechanisms. For example, in some embodiments, the user may input the thickness of the components 108, which may facilitate acquisition of certain component characteristics. Other image processing techniques may be additionally/alternatively used for the acquisition of component characteristics such as, but are not limited to, template matching, blob detection, thresholding, and pixel counting.

In some embodiments, the pattern identifier 1004 may extrapolate edge data by extending known edges along consistent trajectories. For example, referring again to FIG. 1, in an embodiment the pattern identifier 1004 may only be able to reliably detect the portion of the edge 112 that does not abut edge 116. The pattern identifier 1004 may therefore extend the detected portion of edge 112 to intersect with a detected edge 114. This type of extrapolation may facilitate reliable detection of component boundaries.

In this embodiment, the pattern identifier 1004 may transmit the detected and/or measured characteristics of the components 108 to a needs correlator 1008. The needs correlator 1008 may be coupled to a needs-list database 1012 having a number of customer orders stored therein. Each of the customer orders may have one or more requested panels of given dimensions. The needs correlator 1008 may generate a correlative mapping correlating the components 108 to the requested panels based at least in part on the characteristics of the components 108.

In an embodiment the needs-list database 1012 may be located remotely from the mapper 908, which may have a network interface to facilitate communication with the needs-list database 1012. The remote location of the needs-list database 1012 may be, for example, at a central site on a manufacturer's premises that may facilitate access and updating from a variety of facilities. In another embodiment, the needs-list database 1012 may be located off-site and may be accessible through public and/or private networks. In other embodiments, the needs-list database 1012 may be locally disposed with respect to the mapper 908.

The needs correlator 1008 may generate the correlative mapping according to a variety of correlating algorithms. In an embodiment a correlating algorithm may attempt to utilize as much of the components 108 as possible and may therefore correlate a requested panel with the smallest possible component 108 that would fill the order. In an embodiment, a correlating algorithm may have requested panels of high priority and may therefore correlate them with the components 108 on a prioritized basis.

The correlative mapping may be transferred to the cut map generator 916, which may generate the cut map based at least in part on the correlations within the correlative mapping. For example, the cut map may provide cutting details to cut a particular component 108 (and underlying portion of the panel 100) in the dimensions of the requested panel to which it is correlated, thereby extracting a component panel to meet the requested panel order.

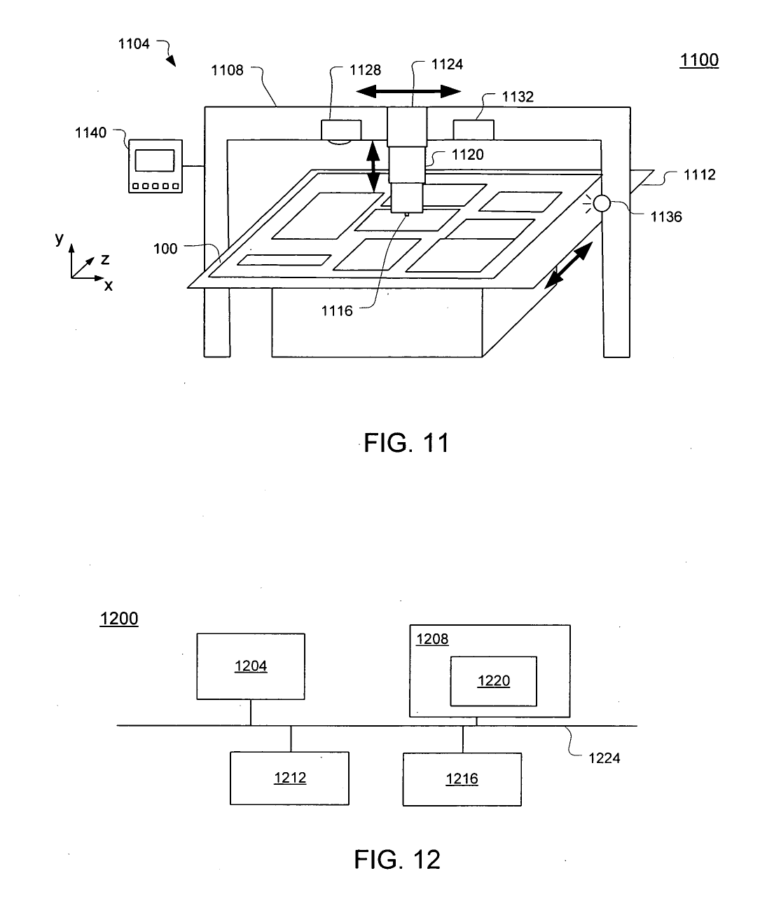

FIG. 11 illustrates a CPE facility 1100 in accordance with an embodiment of the present invention. The CPE facility 1100 may be substantially interchangeable with CPE facilities 332 and 900 shown and described above. In the present embodiment, the CPE facility 1100 may comprise a CNC router 1104 having a bridge 1108 to support various elements and a table 1112 to receive the panel 100. The CNC router 1104 may include a cutting tool 1116 on a telescopic extension 1120 that is coupled to the bridge by a carriage 1124. The cutting tool 1116 may be provided motion in the y-direction by the telescopic extension 1120; motion in the x-direction by the carriage 1124 traveling along the bridge 1108; and relative motion in the z-direction by movement of the table 1112.

Elements of an image acquisition device may be coupled to the bridge 1008, such as, a projector 1128, a camera 1132, and a light source 1136. In an embodiment, the light source 1136, and positioning thereof, may be used to facilitate edge detection. For example, the light source 1136 may cast light at a relatively flat angle across the surface to be inspected. This may result in any three-dimensional objects, e.g., the components 108, casting shadows with a correlated bright spot. An image captured from above, e.g., by the camera 1132, may provide an indication of the size and/or depth of the objects based on the intensity and size of the shadow and/or bright spots.

The CPE facility 1100 may have a computing device 1140 to provide process and control functions to the CNC router 1104. In an embodiment, the computing device 1140 may control the projector 1128 to project a reference image onto the panel 100 and may subsequently control the camera 1132 to capture the image and transmit an image signal representing the captured image to the computing device 1140. The computing device 1140 may cooperatively control the movement of portions of the CNC router 1104, e.g., the table 1112, in order to facilitate this image capture.

The computing device 1140 may receive the image signal and generate a cut map based at least in part on the captured image as described in the above embodiments.

In some embodiments, the computing device 1140 may control the projector 1128 to output the cut map onto the panel 100 for visual verification of the cutting pattern.

The computing device 1140 may control the CNC router 1104 to implement the cut map to cut the panel 100 into a number of component panels that correspond to requested panels to which they have been correlated.

FIG. 12 illustrates an example extraction system 1200 incorporated with at least some of the teachings of the earlier described embodiments of the computing device 1140. In this embodiment, the system 1200 may have a processor/controller 1204, a memory 1208, and an input/output interface 1212, and a network interface 1216 coupled to each other via bus 1224.

In various embodiments, the processor/controller 1204 may include one or more microprocessor, digital signal processors (DSPs), application specific integrated circuits (ASICs), and combinations of various hardware and logic circuitry for performing at least the functions described herein. In various embodiments, the processor/controller 1204, or elements thereof, may be a resource dedicated to the extraction system 1200 or a shared resource.

The memory 1208 may be employed to store instructions and/or data, more specifically, extraction control logic 1220. The extraction control logic 1220 may be employed to perform one or more functions such as, but not limited to, image acquisition, image processing, correlative mapping, and/or cut map generation as described above.

Communication between the extraction system 1200 and various peripherals, such as, but not limited to an image acquisition device and/or a cutting device may be conducted through the input/output interface 1212.

Communication between the extraction system 1200 and remote elements, such as, but not limited to a needs-list database, may be conducted through the network interface 1216.

In alternate systems, application specific integrated circuits (ASICs) may be employed with or as an alternative to the processor/controller 1204, the memory 1208, and the extraction control logic 1220.

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. An apparatus comprising:
an image processor to receive an image signal representing an image of a panel having a plurality of components coupled to a surface of a substrate of the panel, and to identify characteristics of the plurality of components based at least in part on the image signal; and
a cut map generator, coupled to the image processor, to generate a cut map for cutting the plurality of components into a plurality of component panels based at least in part on the identified characteristics of the plurality of components.

2. The apparatus of claim 1, further comprising:
a needs correlator, coupled to the image processor and to a needs-list database, to receive the identified characteristics of the plurality of components from the image processor, to receive a needs-list having a plurality of requested panels from the needs-list database, and to generate a correlative mapping correlating each of the plurality of components to a selected one of the plurality of requested panels based at least in part on the identified characteristics of the plurality of components.

3. The apparatus of claim 2, wherein the cut map generator is coupled to the needs correlator to receive the correlative mapping and to generate the cut map for cutting the plurality of components into the plurality of component panels based at least in part on the correlative mapping.

4. The apparatus of claim 1, wherein the panel is a plywood panel and the plurality of components comprise a plurality of veneer components.

5. The apparatus of claim 1, wherein the identified characteristics of the plurality of components include dimensions for each of the plurality of components.

6. The apparatus of claim 1, wherein the identified characteristics of the plurality of components include a layout of the plurality of components on the substrate.

7. A system comprising:
an image-capture device to generate an image signal representing an image of a panel having a plurality of components coupled to a surface of a substrate of the panel; and
a mapping device to receive the image signal from the image-capture device via a first interface, to receive a needs-list having a plurality of requested panels from a remote needs-list database via a second interface, and to generate a cut map for cutting the plurality of components into a plurality of component panels based at least in part on the image signal and the needs-list.

8. The system of claim 7, wherein the mapping device is to identify characteristics of the plurality of components based at least in part on the image signal and to generate the cut map based at least in part on the identified characteristics of the plurality of components.

9. The system of claim 8, wherein the identified characteristics of the plurality of components include dimensions for each of the plurality of components.

10. The system of claim 8, wherein the identified characteristics of the plurality of components include a layout of the plurality of components on the substrate.

11. The system of claim 8, wherein the mapping device is:
to generate a correlative mapping correlating each of the plurality of components to a selected one of the plurality of requested panels based at least in part on the identified characteristics of the plurality of components; and
to generate the cut map for cutting the plurality of components into the plurality of component panels based at least in part on the correlative mapping.

12. The system of claim 7, further comprising:
a cutting device, coupled to the mapping device, to receive the cut map and to cut the plurality of components into the plurality of component panels.

13. The system of claim 12, wherein the cutting device comprises a computer numerical controlled router.

14. The system of claim 7, wherein the panel is a plywood panel and the plurality of components comprise a plurality of veneer components.

15. A method comprising:
receiving an image signal representing an image of a panel having a plurality of components coupled to a surface of a substrate of the panel;
identifying characteristics of the plurality of components based at least in part on the image signal; and
generating a cut map for cutting the plurality of components into a plurality of component panels based at least in part on the identified characteristics of the plurality of components.

16. The method of claim 15, further comprising:
receiving a needs-list having a plurality of requested panels from a needs-list database; and
correlating each of the plurality of components to a selected one of the plurality of requested panels based at least in part on the identified characteristics.

17. The method of claim 16, wherein said generating of the cut map is further based at least in part on said correlating of each of the plurality of components to a selected one of the plurality of requested panels.

18. An article comprising:
a storage medium; and
instructions stored in the storage medium, which, when executed by a processing device of a mapper cause the mapper to:
receive an image signal representing an image of a panel having a plurality of components coupled to a surface of a substrate of the panel;
identify characteristics of the plurality of components based at least in part on the image signal; and
generate a cut map for cutting the plurality of components into a plurality of component panels based at least in part on the identified characteristics of the plurality of components.

19. The article of claim 18, wherein the instructions, which when executed, further cause the mapper to:
receive a needs-list having a plurality of requested panels from a needs-list database; and
correlate each of the plurality of components to a selected one of the plurality of requested panels based at least in part on the identified characteristics.

20. The article of claim 19 wherein the instructions, which when executed, further cause the mapper to,
generate the cut map based at least in part on said correlating of each of the plurality of components to a selected one of the plurality of requested panels.
